(19) United States
(12) Patent Application Publication
(10) Pub. No.: US 2024/0336512 A1
(43) Pub. Date: Oct. 10, 2024

(54) METHODS AND APPARATUS FOR FABRICATING GLASS SUBSTRATES FOR USE IN MAGNETIC RECORDING MEDIA

(71) Applicant: Western Digital Technologies, Inc., San Jose, CA (US)

(72) Inventors: Shoji Suzuki, San Jose, CA (US); Siew Fu Chai, Sarawak (MY); Tze Ming Pui, Sarawak (MY)

(21) Appl. No.: 18/222,849

(22) Filed: Jul. 17, 2023

Related U.S. Application Data
(60) Provisional application No. 63/457,598, filed on Apr. 6, 2023.

(51) Int. Cl. C03B 33/09

(52) U.S. Cl. CPC C03B 33/093

(57) ABSTRACT

Methods and apparatus for fabricating glass substrates for use in magnetic recording media are described. A support plate for fabricating a glass substrate disk from a glass sheet includes a baseplate, a first circular protrusion disposed on the baseplate and configured to provide a support surface for an inner diameter edge of the glass substrate disk and to enclose a first recess configured to receive a circular portion of the glass sheet after separation of the circular portion, a second circular protrusion disposed on the baseplate and configured to provide a support surface for an outer diameter edge of the glass substrate disk, and vacuum holes to facilitate application of a vacuum on a portion of the glass sheet to affix the glass sheet to the support plate. Further, a method and an apparatus for fabricating the glass substrate disk using the support plate are described.

### CROSS-REFERENCE TO RELATED APPLICATIONS

This application claims priority to and the benefit of U.S. Provisional Patent Application No. 63/457,598, filed on Apr. 6, 2023 entitled, “METHODS AND APPARATUS FOR FABRICATING GLASS SUBSTRATES FOR USE IN MAGNETIC RECORDING MEDIA.” the entire content of which is incorporated herein by reference.

### FIELD

The present disclosure relates to magnetic recording media, and more specifically, to methods and apparatus for fabricating glass substrates from glass sheets where the glass substrates are configured for use in magnetic recording media.

### INTRODUCTION

Magnetic storage systems, such as a hard disk drive (HDD), are utilized in a wide variety of devices in both stationary and mobile computing environments. Examples of devices that incorporate magnetic storage systems include desktop computers, portable notebook computers, portable hard disk drives, digital versatile disc (DVD) players, high-definition television (HDTV) receivers, vehicle control systems, cellular or mobile telephones, television set top boxes, digital cameras, digital video cameras, video game consoles, and portable media players.

A typical disk drive includes magnetic storage media in the form of one or more flat disks or platters. The disks are generally formed of two main substances, namely, a substrate material that gives it structure and rigidity, and a magnetic media coating that holds the magnetic impulses or moments that represent data in a recording layer within the coating. The typical disk drive also includes a read head and a write head, generally in the form of a magnetic transducer which can sense and/or change the magnetic fields stored on the recording layer of the disk. When magnetic storage media uses a non-conductive substrate (such as a glass substrate and/or glass ceramic substrate), a conductive pre-seed layer may be deposited on the non-conductive substrate so that a bias voltage can be applied during the deposition of some or all of the subsequent media films to form the magnetic storage media. In some aspects, by utilizing a product such as a glass sheet that already exists for other applications (e.g., for a cover glass, flat panel, etc.), one or more disks may be produced in a cost-effective way, where the non-conductive substrate may be a glass substrate fabricated from a glass sheet. For example, the glass sheet may be cut into glass substrates, and each glass substrate may be subjected to further processing to form a magnetic recording disk. This process of cutting the glass sheet into glass substrates can however be improved.

### SUMMARY

In one aspect, a method of fabricating a glass substrate disk for a data storage device is provided. The method includes placing a glass sheet on a support plate comprising a plurality of vacuum holes configured to facilitate application of a vacuum on the glass sheet, and applying a first laser to form a plurality of first holes through the glass sheet along a first circular path to correspond to an inner diameter edge of the glass substrate disk and to form a plurality of second holes through the glass sheet along a second circular path to correspond to an outer diameter edge of the glass substrate disk. The method further includes applying a second laser to cut the glass sheet along the first circular path, the second laser having a greater wavelength than that of the first laser, applying the vacuum to the glass sheet via the plurality of vacuum holes to affix the glass sheet on the support plate and to cause, in conjunction with gravity, a circular portion of the glass sheet with a perimeter corresponding to the first circular path to be separated from the glass sheet, and applying the second laser to cut the glass sheet along the second circular path while applying the vacuum to cause, in conjunction with gravity, a remaining portion of the glass sheet to be separated from the glass substrate disk disposed on the support plate.

In another aspect, a support plate for fabricating a glass substrate disk for a data storage device from a glass sheet is provided. The support plate includes a baseplate, a first circular protrusion disposed on a top surface of the baseplate, wherein the first circular protrusion is configured to provide a support surface for an inner diameter edge of the glass substrate disk and to enclose a first recess configured to receive a circular portion of the glass sheet after separation of the circular portion, a second circular protrusion disposed on the top surface of the baseplate, wherein the second circular protrusion is configured to provide a support surface for an outer diameter edge of the glass substrate disk, and a plurality of vacuum holes configured to facilitate application of a vacuum on a portion of the glass sheet to affix the glass sheet to the support plate when the glass sheet is disposed on the first circular protrusion and the second circular protrusion.

In another aspect, an apparatus for cutting the glass sheet to fabricate the glass substrate disk for data storage is provided. The apparatus includes the support plate described above, a first laser device configured to apply a first laser to form a plurality of first holes through the glass sheet along a first circular path to correspond to an inner diameter edge of the glass substrate disk and to form a plurality of second holes through the glass sheet along a second circular path to correspond to an outer diameter edge of the glass substrate disk, a second laser device configured to apply a second laser to cut the glass sheet along the first circular path and along the second circular path, the second laser having a greater wavelength than that of the first laser, a vacuum device configured to apply the vacuum to the glass sheet via the plurality of vacuum holes to affix the glass sheet on the support plate and to cause, in conjunction with gravity, a circular portion of the glass sheet with a perimeter corresponding to the first circular path to be separated from the glass sheet, and a platform configured to move the support plate in at least one direction, relative to at least one of the first laser device or the second laser device.

### BRIEF DESCRIPTION OF THE DRAWINGS

FIG. 1A illustrates a top plan view of a data storage device including a disk shaped magnetic recording medium (magnetic recording disk) in accordance with some aspects of the disclosure.

FIG. 1B illustrates a profile view of a slider and the magnetic recording medium of FIG. 1A in accordance with some aspects of the disclosure.

FIG. 2 is an example diagram illustrating fabrication of glass substrate disks from a glass sheet that are configured to be further processed to form magnetic recording disks in accordance with some aspects of the disclosure.

FIG. 3 illustrates a perspective view of an exemplary support plate for fabricating glass substrate disks for a data storage device from a glass sheet, according to some aspects.

FIG. 4 illustrates a perspective view of an exemplary support plate for fabricating a glass substrate disk for a data storage device from a glass sheet and a cross-section view of the support plate, according to some aspects.

FIG. 5 illustrates a perspective view of a glass sheet and a cross-section view of the glass sheet disposed on the support plate of FIG. 4, according to some aspects.

FIGS. 6A-6E illustrate an exemplary process for fabricating a glass substrate disk for a data storage device, according to some aspects.

FIG. 7 illustrates an exemplary diagram of an apparatus for cutting a glass sheet to fabricate a glass substrate disk for data storage, according to some aspects.

FIG. 8 illustrates a method for fabricating a glass substrate disk for a data storage device, according to some aspects.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

Magnetic recording disks for magnetic storage devices may be manufactured by cutting glass substrates from a large glass sheet and depositing various layers on the glass substrates to form the magnetic recording disks. For example, a laser may be used to cut the glass sheet into suitable shapes, such as the disk shaped glass substrates for the magnetic recording disks. After cutting the glass sheet, the glass substrates need to be separated from the rest of the glass sheet without damaging the glass substrates. The glass substrates have a disk shape with a center hole such that the disk shape may be defined by an inner diameter (ID) and an outer diameter (OD). When cuts are made in the glass sheet to form the disk shape of the glass substrate, a portion of the glass sheet inside the ID of the glass substrate (e.g., to form the center hole) may be referred to as an ID waste and a portion of the glass sheet outside the OD of the glass substrate (e.g., to form the OD outer edge of the disk) may be referred to as an OD waste. The OD waste may be removed with release cuts (e.g., sacrificial cuts) added to an unused portion of glass sheet that is not used for forming the glass substrates. This technique divides the OD waste into several pieces, which makes the removal of the glass substrate from the glass sheet easier. However, in this technique, the ID waste is removed with no release cuts, and thus the chances of damaging the glass substrate during the process of separating the ID waste from the glass substrate are high. If the damage includes a crack on the glass substrate, it may destroy the glass substrate itself. If the damage includes chipping on the glass substrate, it may not destroy the glass substrate, but subsequent processes may be needed to address the chipping, which may be costly in terms of time and budget. Hence, an improved approach to separate a glass substrate from a glass sheet is desired.

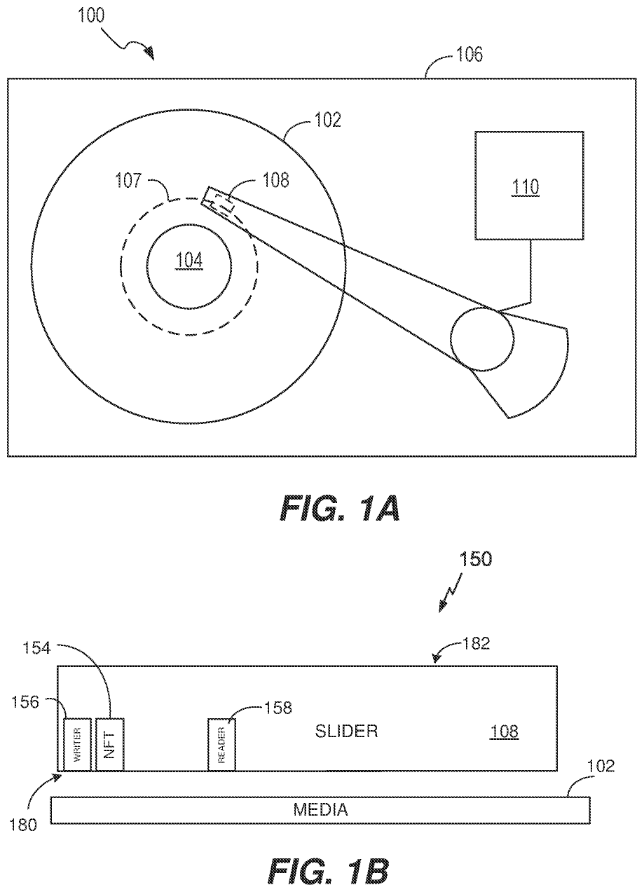

FIG. 1A is a top schematic view of a data storage device 100 configured for magnetic recording and including a disk shaped magnetic recording medium 102 in accordance with some aspects of the disclosure. In illustrative examples, the magnetic recording medium 102 is configured for perpendicular magnetic recording (PMR). However, other recording media, such as media configured for heat assisted magnetic recording (HAMR) or microwave assisted magnetic recording (MAMR) may be used in other examples. The magnetic storage device 100 may include one or more disks/media 102 to store data. Disk/media 102 resides on a spindle assembly 104 that is mounted to drive housing 106. Data may be stored along tracks 107 along the magnetic recording layer of disk 102. The reading and writing of data are accomplished with the head/slider 108 that may have both read and write elements. The write element is used to alter the properties of the magnetic recording layer of disk 102 and thereby write information thereto. In one embodiment, recording head 108 may have magneto-resistive (MR), or giant magneto-resistive (GMR) elements, such as tunnel magneto-resistive (TMR) elements for reading, and a write pole with coils that can be energized for writing. In another embodiment, head 108 may be another type of head, for example, an inductive read/write head or a Hall effect head. In operation, a spindle motor (not shown) rotates the spindle assembly 104, and thereby rotates disk 102 to position head 108 at a particular location along a desired disk track 107. The position of the head 108 relative to the disk 102 may be controlled by position control circuitry 110.

FIG. 1B illustrates a profile view of the slider 108 and the magnetic recording medium 102 of FIG. 1A in accordance with some aspects of the disclosure. In particular, FIG. 1B illustrates an assembly 150 that includes the slider 108, a near-field transducer (NFT) 154 (if the head is a heat assisted magnetic recording (HAMR) head), a writer 156 and a reader 158. It is noted that FIG. 1B is not drawn to scale and generally the slider 108 is substantially smaller than the media 102 (e.g., as shown in FIG. 1A). The NFT 154 may be omitted in a non-HAMR head, and other components may be used instead in other types of energy assisted recording technology (e.g., a spin torque oscillator (STO) in a microwave assisted magnetic recording (MAMR) head). The assembly 150 may further include a laser (not shown) configured to direct light energy to the NFT 154 during a writing process, wherein the NFT may generate localized heat energy, in response to the light energy, to assist the writing process. The laser may be mounted to or made integral to the slider 108. If the slider 108 is not configured for HAMR (e.g., is configured for non-HAMR applications), the laser and NFT may be omitted. The assembly 150 is positioned over the media 102. The slider 108 may be one component or several components. The slider 108 may include a slider body and a slider head. In some implementations, a slider head may be a separate component that may be integrated with the slider 108. The NFT 154, the writer 156 and the reader 158 may be implemented in the slider, the slider head or combinations thereof.

The slider 108 includes a first surface 180 (e.g., bottom surface) that faces the media 102. The first surface 180 may be referred to as an air bearing surface (ABS). The slider 108 also includes a second surface 182 (e.g., top surface) that faces away from the media 102. The NFT 154, the writer 156 and the reader 158 may be located near or along the first surface 180 of the slider 108. The writer 156 may be a writing element (e.g., means for writing data) for writing data on the media 102, and the reader 158 may be a reading element (e.g., means for reading data) for reading data on the media 102. The writer 156 may include a write pole.

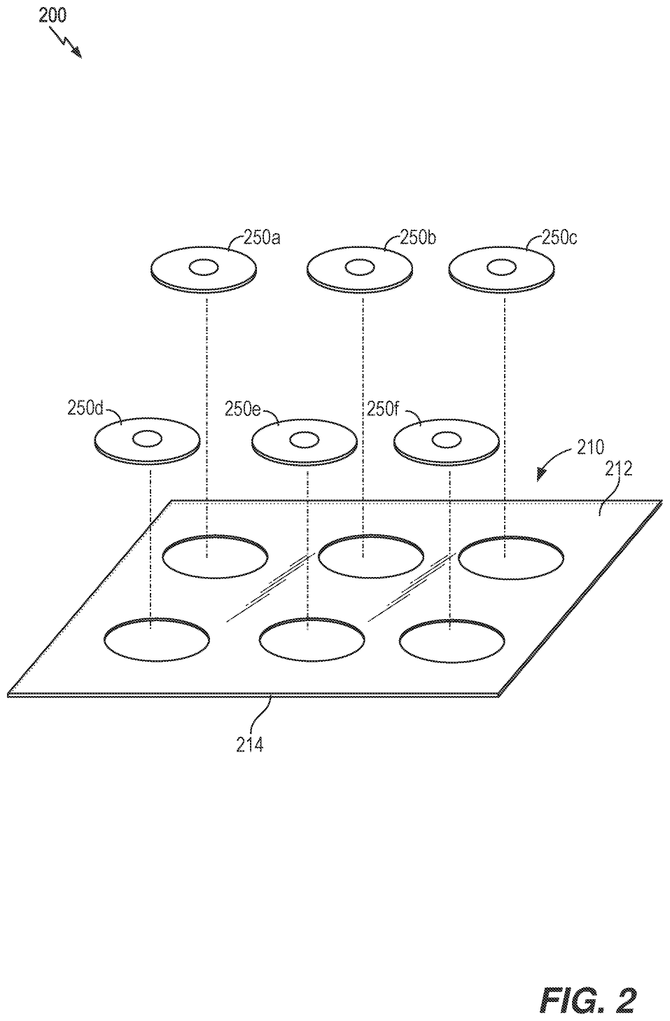

FIG. 2 is an example diagram illustrating fabrication of glass substrate disks from a glass sheet that are configured to be further processed to form magnetic recording disks in accordance with some aspects of the disclosure. To manufacture a magnetic recording disk such as the disk 102 of FIG. 1A, a glass sheet may be cut into multiple glass substrate disks, and the glass substrate disks may be further processed to form magnetic recording disks (e.g., using one or more deposition processes wherein at least one magnetic recording layer is added). As shown in FIG. 2, for example, a glass sheet 210 with a first surface 212 and a second surface 214 are cut into glass substrate disks 230a, 230b, 230c, 230d, 230e, and 230f, which are then processed to form magnetic recording disks (e.g., after undergoing further cutting and various deposition steps). In some examples, the glass sheet may be divided into multiple regions from which multiple glass substrate disks for magnetic recording disks are cut. In the example illustrated in FIG. 2, the glass sheet 210 is divided into six regions, and the glass substrates 230a, 230b, 230c, 230d, 230e, and 230f are cut from the six regions, respectively. In other examples, the glass sheet may be divided into less than or greater than six regions depending on the size of the glass substrates desired and the size of the glass sheet.

A glass sheet is generally an unfinished sheet of glass that may have foreign substances, defects, and/or roughness. Glass substrate disks for the magnetic recording disks generally require a smooth surface with few or no defects. Therefore, after cutting the glass sheet into glass substrate disks, multiple polishing steps and/or a lapping process may be applied to each glass substrate disk to achieve the desired smoothness in the surface and/or to adjust a thickness of the glass substrate.

A laser may be utilized to cut glass substrate disks such as the glass substrate disks 230a, 230b, 230c, 230d, 230e, and 230f from a glass sheet. In one example, two different types of lasers including a first laser and a second laser may be applied to cut the glass substrate disks from the glass sheet, where the second laser has a greater wavelength than that of the first laser. For example, the first laser may be a neodymium-doped yttrium aluminum garnet (Nd:YAG) laser (e.g., with a wavelength of 1.064 μm), and the second laser may be a carbon dioxide (CO₂) laser (e.g., with a wavelength of 10.60 μm).

When the glass substrate disks are cut using the laser, the glass sheet should be held in place and the ID waste and the OD waste should be removed with little or no chipping or cracking. Hence, a support plate may be used such that the glass sheet may be placed on the support plate to hold the glass sheet in place and to facilitate the removals of the ID waste and the OD waste.

According to some aspects of the disclosure, a support plate for fabricating a glass substrate disk for a data storage device from a glass sheet may include a baseplate, a first circular protrusion and a second circular protrusion that are disposed on a top surface of the baseplate, and multiple vacuum holes configured to facilitate application of a vacuum on a portion of the glass sheet to affix the glass sheet to the support plate when the glass sheet is disposed on the first circular protrusion and the second circular protrusion. The first circular protrusion may be configured to provide a support surface for an inner diameter edge of the glass substrate disk and to enclose a first recess configured to receive a circular portion (e.g., ID waste) of the glass sheet after separation of the circular portion. The second circular protrusion may be configured to provide a support surface for an outer diameter edge of the glass substrate disk.

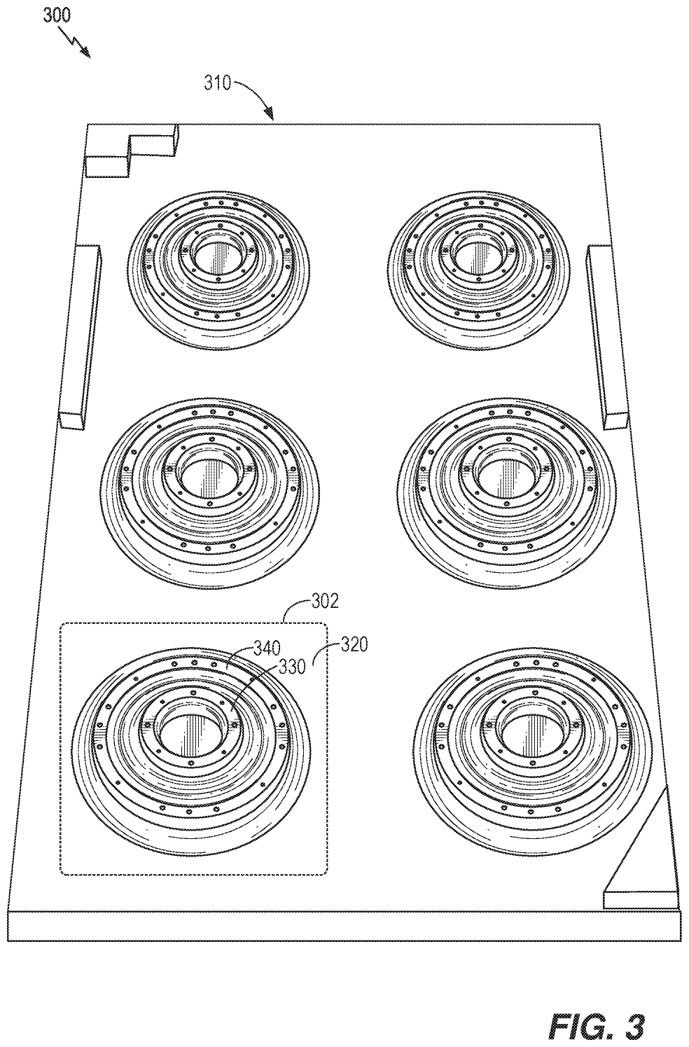

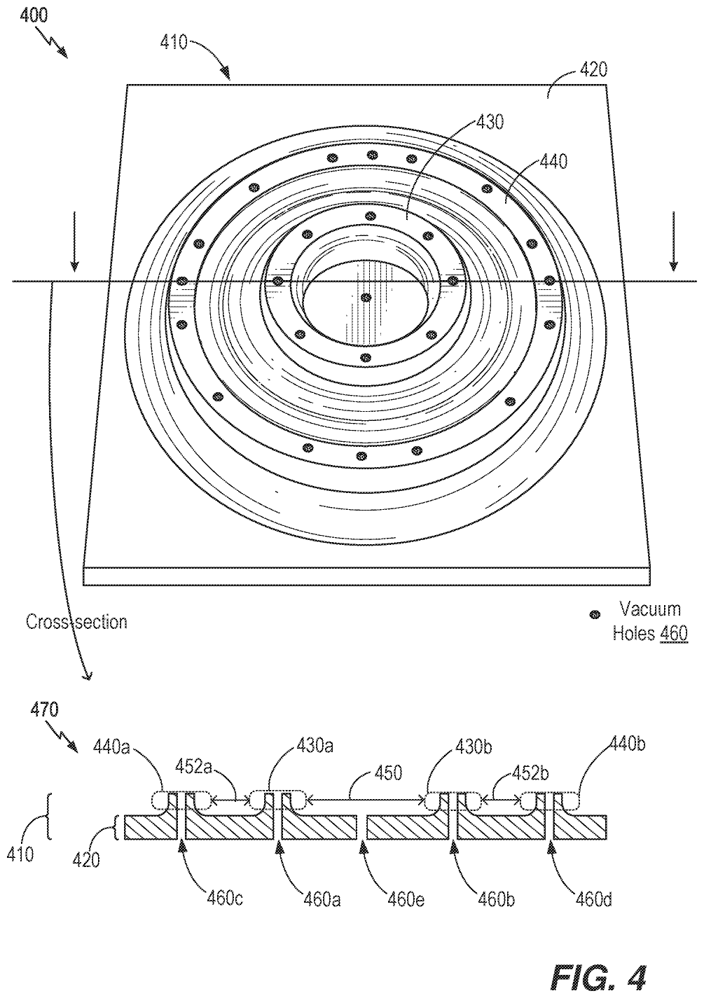

FIG. 3 illustrates a perspective view 300 of an exemplary support plate 310 for fabricating glass substrate disks for a data storage device from a glass sheet, according to some aspects. As discussed above, the glass sheet may be placed on the support plate 310 before a process of cutting one or more glass substrate disks from the support plate 310. The support plate may include one region or multiple regions, where each region has the first circular protrusion, the second circular protrusion, and the multiple vacuum holes, as discussed above. If the support plate includes multiple regions, then the multiple regions may share the same baseplate. In the example illustrated in FIG. 3, the support plate 310 includes 6 regions, with each region having its own first circular protrusion, second circular protrusion, and multiple vacuum holes. The 6 regions shown in FIG. 3 share the same baseplate 320. For example, a region 302 has a first circular protrusion 330, a second circular protrusion 340, and multiple vacuum holes (shown as black circles). The details on the first circular protrusion 330, the second circular protrusion 340, and the multiple vacuum holes are provided below, in reference to FIG. 4.

FIG. 4 illustrates a perspective view 400 of an exemplary support plate 410 for fabricating a glass substrate disk for a data storage device from a glass sheet and a cross-section view 470 of the support plate, according to some aspects. As discussed above, the support plate may have a single region or may have multiple regions. In one example, if the support plate has multiple regions, then each region may have the same features as the features shown in FIG. 4.

The support plate 410 may include a baseplate 420, a first/inner circular protrusion 430 and a second/outer circular protrusion 440 that are disposed on a top surface of the baseplate 420, and multiple vacuum holes 460 configured to facilitate application of a vacuum on a portion of the glass sheet to affix the glass sheet to the support plate when the glass sheet is disposed on the first circular protrusion 430 and the second circular protrusion 440. For example, a vacuum device may apply the vacuum on the portion of the glass sheet that aligns with the vacuum holes 460 when the glass sheet is disposed on the first circular protrusion 430 and the second circular protrusion 430 by sucking air via the vacuum holes 460, thereby affixing the glass sheet to the support plate 410. In an example, the support plate 410 shown in FIG. 4 may correspond to a region 302 of the support plate 310 shown in FIG. 3. Hence, the first circular protrusion 330, the second circular protrusion 340, and the multiple vacuum holes in FIG. 3 may correspond to the first circular protrusion 430, the second circular protrusion 440, and the multiple vacuum holes 460 of FIG. 4.

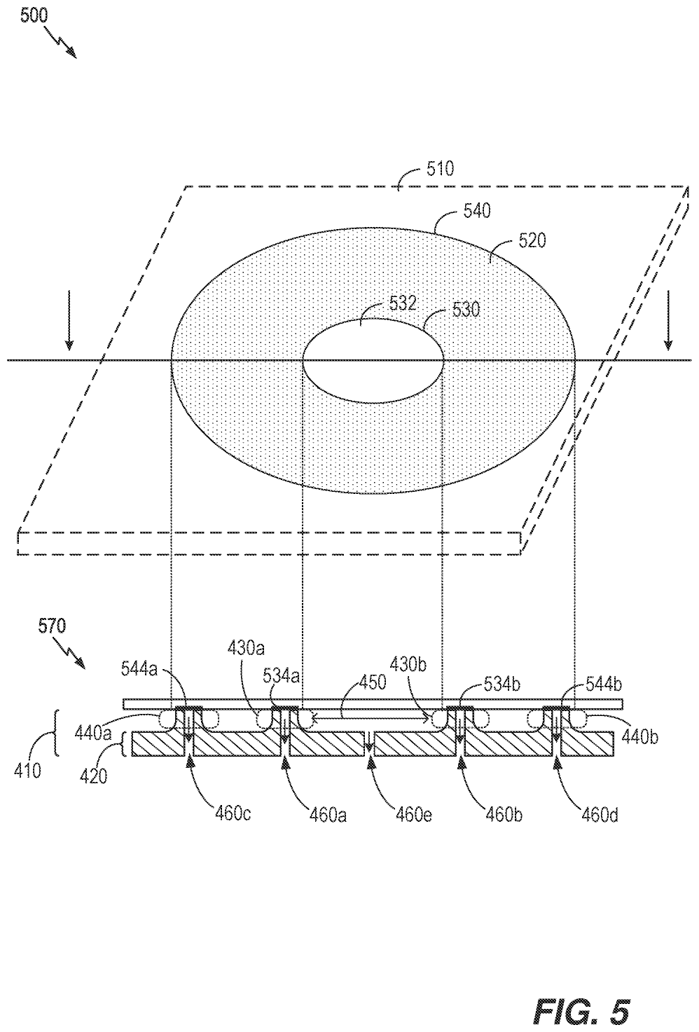

FIG. 5 illustrates a perspective view 500 of a glass sheet 510 and a cross-section view 570 of the glass sheet 510 disposed on the support plate 410 of FIG. 4, according to some aspects. As shown in FIG. 5, the glass sheet 510 may have a disk portion 520 (in a shaded area) that is to be cut from the glass sheet 510 to form a glass substrate disk. The disk portion 520 may include a first circular path 530 that corresponds to an inner diameter edge of the glass substrate disk and a second circular path 540 that corresponds to an outer diameter edge of the glass substrate disk. Features of the support plate 410 are further described in reference to FIG. 4 and FIG. 5, as follows.

The cross-section view 470 of FIG. 4 may be a view of a cross section taken across a plane extending in a radial direction of the first circular protrusion 430 and/or a view of a cross section taken across a plane extending in a radial direction of the first circular protrusion 430. The cross-section view 470 shows first circular protrusion portions 430a and 430b that form the first circular protrusion 430, and second circular protrusion portions 440a and 440b that form the second circular protrusion 440. The first circular protrusion 430 of the support plate 410 may be configured to provide a support surface for an inner diameter edge of the glass substrate disk. The inner diameter edge of the glass substrate disk may be formed by cutting the disk portion 520 around the first circular path 530. The first circular protrusion 430 may enclose a first recess 450 configured to receive a circular portion 532 of the glass sheet 510 after separation of the circular portion 532. For example, when the circular portion 532 is separated from the glass sheet 510, the circular portion 532 (e.g., ID waste) may fall into the first recess 450.

The second circular protrusion 440 of the support plate 410 may be configured to provide a support surface for an outer diameter edge of the glass substrate disk formed by cutting the disk portion 520. The outer diameter edge of the glass substrate disk may be formed by cutting the disk portion 520 around the second circular path 540.

In some aspects, the first circular protrusion 430 may include one or more vacuum holes such as vacuum holes 460a and 460b configured to facilitate application of the vacuum on a first portion 534a, 534b of the glass sheet 510 in contact with the first circular protrusion 430. Hence, for example, as shown by the downward arrows inside the vacuum holes 460a and 460e in FIG. 5, the vacuum may be applied through the vacuum holes 460a and 460b such that the first portion 534a, 534b of the glass sheet 510 may be affixed on the first circular protrusion 430, via the vacuum. In some aspects, the second circular protrusion 440 includes one or more vacuum holes such as vacuum holes 460c and 460d configured to facilitate application of the vacuum on a second portion of the glass sheet 510 in contact with the first circular protrusion 440. Hence, for example, as shown by the downward arrows inside the vacuum holes 460c and 460d in FIG. 5, the vacuum may be applied through the vacuum holes 460c and 460d such that the second portion 544a, 544b of the glass sheet 510 is affixed on the second circular protrusion 440, via the vacuum.

Optionally, in some aspects, the first recess may include at least one vacuum hole such as a vacuum hole 460e configured to facilitate application of the vacuum on the circular portion 532 of the glass sheet 510. For example, as shown by the downward arrow inside the vacuum hole 460e, the vacuum may be applied through the vacuum hole 460e to apply a downward force on the circular portion 532. In an example, the vacuum applied through the vacuum hole 460e may help the circular portion 532 to separate from the glass sheet 510 after the circular portion 532 is cut.

In some aspects, the second circular protrusion 440 may enclose a second recess 452 (452a and 452b) disposed between the first circular protrusion 440 and the first circular protrusion 430. The cross-section view 470 shows that second circular protrusion portions 440a and 440b may form the second circular protrusion 440.

Because the glass sheet 510 is disposed on a support surface provided by the first circular protrusions 430 and a support surface provided by the second circular protrusions 440, the glass sheet 510 contacts the support plate 410 by the first portion 534a. 534b of the glass sheet 510 being in contact with the first circular protrusion 430 and the second portion 544a, 544b of the glass sheet 510 being in contact with the second circular protrusions 440. Because only a portion of the disk portion 520 of the glass sheet 510 contacts the support plate 410, a contact area may be minimized to avoid any unnecessary contact between the glass sheet 510 and the support plate 410, and thus any potential damage from the disk portion 520 of the glass sheet 510 being in contact with the support plate 410 may be minimized.

In some aspects, as shown in FIG. 4, a cross sectional shape of the first circular protrusion 430, taken across a plane extending in a radial direction of the first circular protrusion 430, may include a first flat top mountain shape (e.g., at 430a and 430b) where the glass sheet 510 is configured to rest on a first flat portion of the first flat top mountain shape. As shown in the cross-section view 470, the first flat top mountain shape has a flared base and has a vacuum hole through the first flat top mountain shape. In some aspects, as shown in FIG. 4, a cross sectional shape of the second circular protrusion 440, taken across a plane extending in a radial direction of the second circular protrusion 440, may include a second flat top mountain shape (e.g., at 440a and 440b) where the glass sheet is configured to rest on a second flat portion of the second flat top mountain shape. As shown in the cross-section view 470, the second flat top mountain shape has a flared base and has a vacuum hole through the first flat top mountain shape.

It is understood that the shapes of the first circular protrusion 430 and the second circular protrusion 440 shown in FIG. 4 are merely exemplary embodiments, and such shapes are not limited to the exemplary embodiments shown in FIG. 4. In another example, the cross-sectional shape of the first circular protrusion of the support plate may be a first rectangular shape, instead of the first flat top mountain shape, and the cross-sectional shape of the second circular protrusion of the support plate may be a second rectangular shape, instead of the second flat top mountain shape.

In some aspects, the first circular path 530 and the second circular path 540 may be concentric. Further, in some aspects, the glass substrate disk (e.g., corresponding to the disk portion 520), the first circular protrusion 430, and the first circular protrusion 440 may be concentric. As such, when the vacuum is applied via the vacuum holes 460, a pressure or a force caused by the vacuum may be applied uniformly to the disk portion 520 due to the concentricity. Hence, when the cut is made along the first circular path 530, the circular portion 532 may be separated from the glass sheet 510 by applying the vacuum, which generates an air pressure or a force (e.g., a substantially uniform force) to cause the circular portion 532 to separate from the glass sheet 510.

As discussed above, the support plate according to the disclosure, such as the support plate 410, may be used to place a glass sheet thereon, while glass substrate disks are cut from the glass sheet using the support plate as a cutting platform. To cut each glass substrate disk, the first laser may be applied to form the multiple first holes through the glass sheet along the first circular path corresponding to an inner diameter edge of the glass substrate and to form multiple second holes through the glass sheet along the second circular path to correspond to an outer diameter edge of the glass substrate disk. The first and second holes may be referred to as filaments, and may have a diameter of 3 to 7 μm, for example. At this stage, because the first and second holes are not connected, the glass substrate disk cannot be separated from the rest of the glass sheet. Therefore, subsequently, the second laser may be applied to cut the glass sheet along the first circular path and the second circular path. For example, the second laser may generate new cuts that connect the first holes to each other to cut (e.g., further cut) the glass sheet along the first circular path and may generate new cuts that connect the second holes to each other to cut (e.g., further cut) the glass sheet along the second circular path.

According to some aspects of the disclosure, approaches to cut the glass substrate disk from the glass sheet while utilizing the vacuum holes are provided. As discussed above, the support plate according to the disclosure has the multiple vacuum holes. In particular, according to some aspects, after placing a glass sheet on the support plate, the first laser is applied to form first holes through the glass sheet along the first circular path to correspond to the inner diameter edge of the glass substrate disk and to form second holes through the glass sheet along the second circular path to correspond to the outer diameter edge of the glass substrate disk. After applying the first laser, the second laser is applied to cut the glass sheet along the first circular path, where the second laser has a greater wavelength than that of the first laser. Then, the vacuum is applied to the glass sheet via the multiple vacuum holes to affix the glass sheet on the support plate and to cause, in conjunction with gravity, the circular portion of the glass sheet to be separated from the glass sheet. Subsequently, the second laser is applied to cut the glass sheet along the second circular path while applying the vacuum to cause, in conjunction with gravity, a remaining portion of the glass sheet to be separated from the glass substrate disk disposed on the support plate.

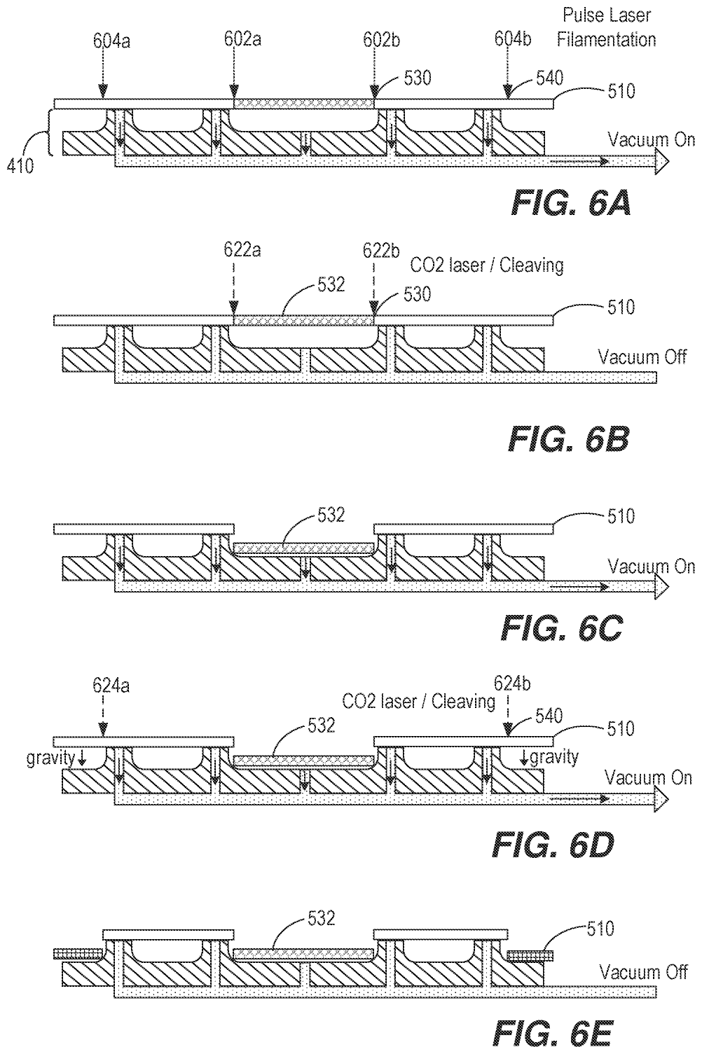

FIGS. 6A-6E illustrate an exemplary process for fabricating a glass substrate disk for a data storage device, according to some aspects. For example, during the process in FIGS. 6A-6E, the support plate 400 of FIG. 4 may be used to place the glass sheet 510 thereon.

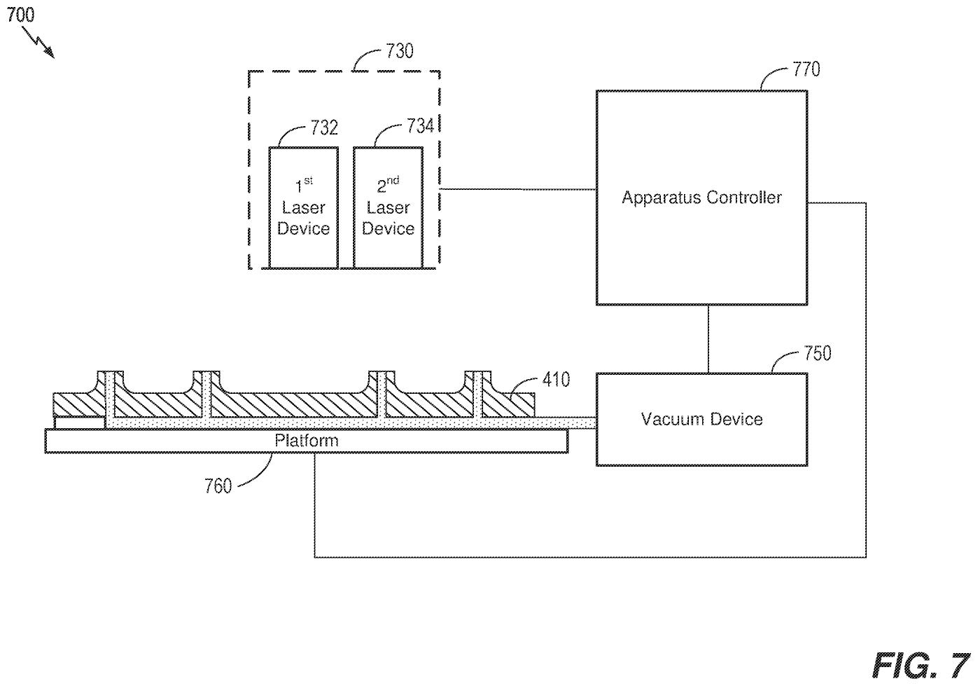

In FIG. 6A, after placing a glass sheet 510 on the support plate 410, the first laser (not shown in FIGS. 6A-6E but see 732 in FIG. 7) is applied to form first holes through the glass sheet 510 along the first circular path 530 to correspond to the inner diameter edge of the glass substrate disk, where the first hole locations are shown by first arrows 602a and 602b. Further, the first laser is applied to form second holes through the glass sheet 510 along the second circular path 540 to correspond to the outer diameter edge of the glass substrate disk, where the second hole locations are shown by second arrows 604a and 604h. In some aspects, as shown in FIG. 6A, the vacuum may be applied on the glass sheet 510 via the multiple vacuum holes 460 to affix the glass sheet 510 on the support plate 410 when placing the glass sheet 510 on the support plate 410, and at preselected times during the process of FIGS. 6A-6E. As such that the first laser may be applied to form the first holes and the second holes while a position of the glass sheet 510 is fixed with respect to the support plate 410 using the vacuum. With the position of the glass sheet 510 is fixed with respect to the support plate 410, the first circular path 530 and the first circular protrusion 430 stay concentric and the second circular path 540 and the second circular protrusion 440 stay concentric, while the first laser is applied. In one aspect, the first laser may be operated in a pulse laser filamentation mode while it forms the first and second holes.

In some aspects, when applying the first laser, a position of the support plate 410 with respect to a position of a first laser device applying the first laser may be changed, so that the first laser may be applied along the first circular path 530 to form the first holes and along the second circular path 540 to form the second holes. In some aspects, the first laser may be a short wavelength laser such as a Nd:YAG laser. In one example, a first laser device configured to apply the first laser may be moved to apply the first laser along the first circular path 530 and second circular path 540. In another example, instead of moving the first laser, a platform holding the support plate 410 may be moved in such a way that the first laser may be applied along the first circular path 530 and the second circular path 540.

In some aspects, after applying the first laser, the glass sheet 510 may be placed at rest for several hours, to allow the glass sheet 510 from stabilize after the application of the first laser.

In FIG. 6B, after applying the first laser, the second laser (not shown in FIGS. 6A-6E but see 734 in FIG. 7) is applied to cut the glass sheet 510 along the first circular path 530, where the second laser has a greater wavelength than that of the first laser. In some aspects, as shown in FIG. 6B, the second laser may be applied to cut the glass sheet 510 along the first circular path 530, as shown by arrows 622a and 622b, with the vacuum turned off. For example, the vacuum may be turned off when the second laser is applied along the first circular path 530 because the vacuum may cause strain and distortions around the circular portion (e.g., ID waste) 532 defined by the first circular path 530 while the second laser is applied. In some aspects, the second laser may cut the glass sheet 510 along the first circular path 530 by cutting and connecting the first holes along the first circular path 530. In some aspects, the second laser may be a carbon dioxide laser. In some aspects, when the second laser is applied in FIG. 6B, a focus of the second laser is optically moved to cut the glass sheet 510 along the first circular path 530 while a position of a second laser device applying the second laser remains about stationary with respect to the glass sheet 510. For example, because the second laser is applied without moving the second laser with respect to the glass sheet 510, the parts associated with the second laser and the glass sheet 510 in the apparatus are mostly stationary and thus the glass sheet 510 does not need to be held in one place using the vacuum. In one aspect, the second laser may be operated in a cleaving mode while cutting and connecting the first and second holes along their respective circular paths.

In FIG. 6C, the vacuum is applied to the glass sheet 510 via the multiple vacuum holes to affix the glass sheet 510 on the support plate 410 and to cause, in conjunction with gravity, the circular portion 532 of the glass sheet 510 to be separated from the glass sheet 510. In some aspects, as shown in FIG. 6C, applying the vacuum may cause, in conjunction with gravity, the circular portion 532 to fall into the first recess. The application of the vacuum may generate air pressure that applies downward force on the circular portion 532 uniformly and concentrically (substantially uniformly and concentrically). As such, without using manual or mechanical actions to separate the circular portion 532, the force caused by the air pressure via the vacuum may gently and uniformly separate the circular portion 532 from the glass sheet 510. Further, the vacuum may work to supplement the gravitational force, and thereby help the circular portion 532 separate from the glass sheet 510 and fall into the first recess.

In FIG. 6D, the second laser is applied to cut the glass sheet 510 along the second circular path 540, as shown by arrows 624a and 624b, while applying the vacuum to cause, in conjunction with gravity, a remaining portion of the glass sheet (e.g., OD waste) 510 to be separated from the glass substrate disk disposed on the support plate 410. In an example, at this stage, the vacuum may be applied to affix the disk portion 520 to the support plate 410 when the second laser is applied to cut along the second circular path 540 because the remaining glass sheet 510 may move around as the second circular path 540 is cut (e.g., due to the weight of the glass sheet 510). In some aspects, when the second laser is applied to cut the glass sheet 510 along the second circular path 540, the focus of the second laser is moved to cut the glass sheet 510 along the second circular path 540 while the position of the second laser device remains about stationary with respect to the glass sheet 510.

In FIG. 6E, the glass substrate disk is prepared as the remaining portion of the glass sheet 510 (e.g., OD waste) is separated from the glass substrate disk. At this stage, the vacuum may be turned off.

FIG. 7 illustrates an exemplary diagram for an apparatus 700 for cutting a glass sheet to fabricate a glass substrate disk for data storage, according to some aspects. In FIG. 7, the apparatus 700 may include the support plate 410 of FIG. 4 (shown in the cross-sectional view) to dispose a glass sheet thereon. The features of the support plate 410 are described above, and thus the descriptions of the support plate 410 are omitted here. The apparatus 700 may further include a first laser device 732 and a second laser device 734. In an example, the first laser device 732 and a second laser device 734 may be implemented within a single laser component 730. In another example, the first laser device 732 and a second laser device 734 may be separate components. The first laser device 732 may be configured to apply a first laser to form first holes through the glass sheet along a first circular path to correspond to an inner diameter edge of the glass substrate disk and to form second holes through the glass sheet along a second circular path to correspond to an outer diameter edge of the glass substrate disk. In some aspects, the first laser may be an Nd:YAG laser. The second laser device 734 may be configured to apply a second laser to cut the glass sheet along the first circular path and along the second circular path, the second laser having a greater wavelength than that of the first laser. In some aspects, the second laser may be a CO₂ laser.

The apparatus 700 may further include a vacuum device 750 configured to apply the vacuum to the glass sheet via the multiple vacuum holes to affix the glass sheet on the support plate 410 and to cause, in conjunction with gravity, a circular portion of the glass sheet with a perimeter corresponding to the first circular path to be separated from the glass sheet.

In some aspects, the apparatus 700 may further include a platform 760 configured to move the support plate 410 in at least one direction, relative to at least one of the first laser device or the second laser device. For example, the platform 760 may include a motor to move the platform 760, so as to move the support plate 410 disposed on the platform 760.

In some aspects, the vacuum device 750 is configured to apply the vacuum on the glass sheet to affix the glass sheet on the support plate 410, and the first laser is configured to form the plurality of first holes and to form the plurality of second holes in conjunction with the vacuum. In some aspects, the second laser is configured to cut the glass sheet along the first circular path without the vacuum.

In some aspects, the platform 760 is configured to move the support plate 410 relative to the first laser device 732 configured to apply the first laser. In some aspects, the second laser device 734 is further configured to optically move a focus of the second laser to cut the glass sheet along the first circular path while the second laser device remains about stationary with respect to the glass sheet. In some aspects, the second laser device 734 is further configured to optically move the focus of the second laser to cut the glass sheet along the second circular path while the second laser device remains about stationary with respect to the glass sheet.

In some aspects, the operation of the apparatus 700 may be controlled by an apparatus controller 770. The apparatus controller 770 may be a part of the apparatus 700 or may exist separately from the apparatus 700. The apparatus controller 770 may be configured to control operations of the first laser device 732, the second laser device 734, the vacuum device 750, and the platform 760.

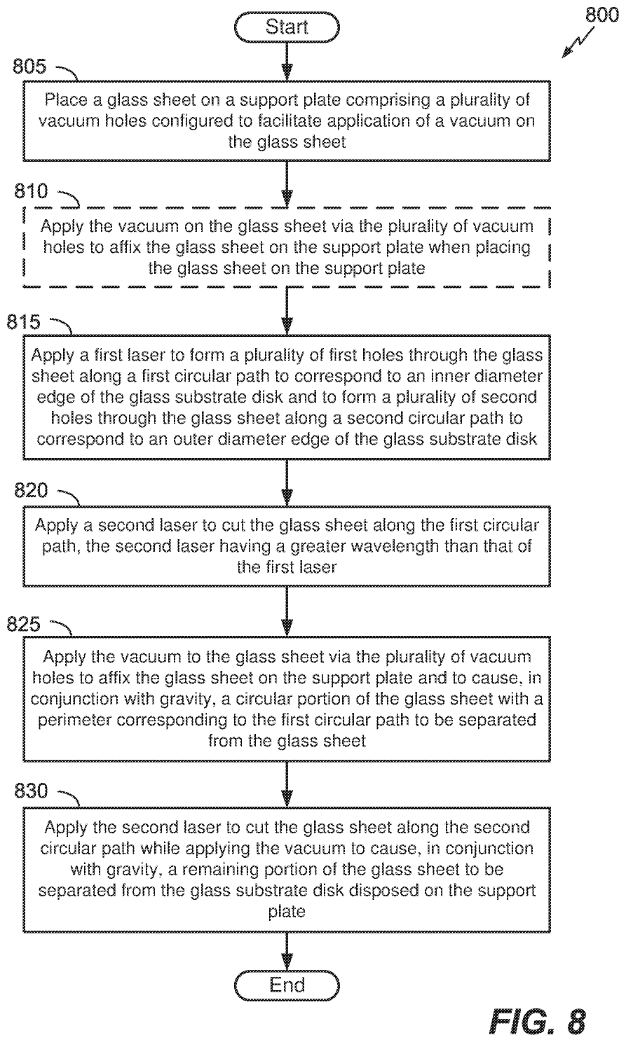

FIG. 8 illustrates a method 800 for fabricating a glass substrate disk for a data storage device, according to some aspects. In some aspects, the method 800 may be performed by an apparatus for cutting the glass sheet to fabricate the glass substrate disk for data storage, such as the apparatus 700 of FIG. 7. At block 805, the apparatus may place a glass sheet on a support plate comprising a plurality of vacuum holes configured to facilitate application of a vacuum on the glass sheet.

In some aspects, at block 810, the apparatus may apply the vacuum on the glass sheet via the plurality of vacuum holes to affix the glass sheet on the support plate when placing the glass sheet on the support plate.

At block 815, the apparatus may apply a first laser to form a plurality of first holes through the glass sheet along a first circular path to correspond to an inner diameter edge of the glass substrate disk and to form a plurality of second holes through the glass sheet along a second circular path to correspond to an outer diameter edge of the glass substrate disk. In some aspects, the applying of the first laser at block 815 may include applying the first laser to form the plurality of first holes and to form the plurality of second holes while applying the vacuum.

At block 820, the apparatus may apply a second laser to cut the glass sheet along the first circular path, the second laser having a greater wavelength than that of the first laser. In some aspects, the first laser may be a neodymium-doped yttrium aluminum garnet (Nd:YAG) laser and the second laser may be a carbon dioxide laser. In some aspects, the applying of the second laser at block 820 may include applying the second laser to cut the glass sheet along the first circular path with the vacuum turned off.

At block 825, the apparatus may apply the vacuum to the glass sheet via the plurality of vacuum holes to affix the glass sheet on the support plate and to cause, in conjunction with gravity, a circular portion of the glass sheet with a perimeter corresponding to the first circular path to be separated from the glass sheet.

In some aspects, the support plate comprises a baseplate and a first circular protrusion disposed on a top surface of the baseplate, wherein the first circular protrusion provides a support surface for the inner diameter edge of the glass substrate disk and encloses a first recess configured to receive the circular portion of the glass sheet after separation of the circular portion. In some aspects, the applying of the vacuum to cause the circular portion of the glass sheet to be separated from the glass sheet at block 825 may include applying the vacuum to cause, in conjunction with gravity, the circular portion to fall into the first recess.

In some aspects, the first recess includes at least one vacuum hole of the plurality of vacuum holes configured to facilitate application of the vacuum on the circular portion of the glass sheet.

In some aspects, the first circular path and the second circular path are concentric. In some aspects, the glass substrate disk, the first circular protrusion, and the second circular protrusion are concentric.

At block 830, the apparatus may apply the second laser to cut the glass sheet along the second circular path while applying the vacuum to cause, in conjunction with gravity, a remaining portion of the glass sheet to be separated from the glass substrate disk disposed on the support plate.

In some aspects, the support plate may further include a second circular protrusion disposed on the top surface of the baseplate, wherein the second circular protrusion provides a support surface for the outer diameter edge of the glass substrate disk. In some aspects, the applying of the vacuum to cause the remaining portion of the glass sheet to be separated from the glass sheet at block 830 may include applying the vacuum to cause, in conjunction with gravity, the remaining portion to fall outside of the second circular protrusion. In some aspects, the second circular protrusion may enclose a second recess disposed between the second circular protrusion and the first circular protrusion. In some aspects, the first circular protrusion may include at least one vacuum hole of the plurality of vacuum holes to facilitate application of the vacuum on a first portion the glass sheet in contact with the first circular protrusion, and the second circular protrusion may include at least one vacuum hole of the plurality of vacuum holes to facilitate application of the vacuum on a second portion of the glass sheet in contact with the second circular protrusion.

In some aspects, the applying the first laser comprises moving a position of the support plate with respect to a position of a first laser device applying the first laser. In some aspects, the applying the second laser to cut the glass sheet along the first circular path comprises optically moving a focus of the second laser to cut the glass sheet along the first circular path while a position of a second laser device applying the second laser remains about stationary with respect to the glass sheet. In some aspects, the applying the second laser to cut the glass sheet along the second circular path comprises optically moving the focus of the second laser to cut the glass sheet along the second circular path while the position of the second laser device remains about stationary with respect to the glass sheet.

It shall be appreciated by those skilled in the art in view of the present disclosure that although various exemplary fabrication methods are discussed herein with reference to magnetic recording disks, the methods, with or without some modifications, may be used for fabricating other types of recording disks, for example, optical recording disks such as a compact disc (CD) and a digital-versatile-disk (DVD), or magneto-optical recording disks, or ferroelectric data storage devices.

Various components described in this specification may be described as “including” or made of certain materials or compositions of materials. In one aspect, this can mean that the component consists of the particular material(s). In another aspect, this can mean that the component comprises the particular material(s).

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. It is further noted that the term “over” as used in the present application in the context of one component located over another component, may be used to mean a component that is on another component and/or in another component (e.g., on a surface of a component or embedded in a component). Thus, for example, a first component that is over the second component may mean that (1) the first component is over the second component, but not directly touching the second component, (2) the first component is on (e.g., on a surface of) the second component, and/or (3) the first component is in (e.g., embedded in) the second component. The term “about ‘value X’”, or “approximately value X”, as used in the disclosure shall mean within 10 percent of the ‘value X’. For example, a value of about 1 or approximately 1, would mean a value in a range of 0.9-1.1. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range.

What is claimed is:

1. A method of fabricating a glass substrate disk for a data storage device, comprising:
placing a glass sheet on a support plate comprising a plurality of vacuum holes configured to facilitate application of a vacuum on the glass sheet;
applying a first laser to form a plurality of first holes through the glass sheet along a first circular path to correspond to an inner diameter edge of the glass substrate disk and to form a plurality of second holes through the glass sheet along a second circular path to correspond to an outer diameter edge of the glass substrate disk;
applying a second laser to cut the glass sheet along the first circular path, the second laser having a greater wavelength than that of the first laser;
applying the vacuum to the glass sheet via the plurality of vacuum holes to affix the glass sheet on the support plate and to cause, in conjunction with gravity, a circular portion of the glass sheet with a perimeter corresponding to the first circular path to be separated from the glass sheet; and
applying the second laser to cut the glass sheet along the second circular path while applying the vacuum to cause, in conjunction with gravity, a remaining portion of the glass sheet to be separated from the glass substrate disk disposed on the support plate.

2. The method of claim 1, further comprising:
applying the vacuum on the glass sheet via the plurality of vacuum holes to affix the glass sheet on the support plate when placing the glass sheet on the support plate; and
wherein the applying the first laser to form the plurality of first holes and to form the plurality of second holes comprises applying the first laser to form the plurality of first holes and to form the plurality of second holes while applying the vacuum.

3. The method of claim 2, wherein the applying the second laser to cut the glass sheet along the first circular path comprises applying the second laser to cut the glass sheet along the first circular path with the vacuum turned off.

4. The method of claim 1, wherein the support plate comprises a baseplate and a first circular protrusion disposed on a top surface of the baseplate, wherein the first circular protrusion provides a support surface for the inner diameter edge of the glass substrate disk and encloses a first recess configured to receive the circular portion of the glass sheet after separation of the circular portion, and
wherein the applying the vacuum to cause the circular portion of the glass sheet to be separated from the glass sheet comprises applying the vacuum to cause, in conjunction with gravity, the circular portion to fall into the first recess.

5. The method of claim 4, wherein the support plate further comprises a second circular protrusion disposed on the top surface of the baseplate, wherein the second circular protrusion provides a support surface for the outer diameter edge of the glass substrate disk, and
wherein the applying the vacuum to cause the remaining portion of the glass sheet to be separated from the glass sheet comprises applying the vacuum to cause, in conjunction with gravity, the remaining portion to fall outside of the second circular protrusion.

6. The method of claim 5, wherein the second circular protrusion encloses a second recess disposed between the second circular protrusion and the first circular protrusion.

7. The method of claim 5,
wherein the first circular protrusion comprises at least one vacuum hole of the plurality of vacuum holes to facilitate application of the vacuum on a first portion the glass sheet in contact with the first circular protrusion; and
wherein the second circular protrusion comprises at least one vacuum hole of the plurality of vacuum holes to facilitate application of the vacuum on a second portion of the glass sheet in contact with the second circular protrusion.

8. The method of claim 5, wherein the first recess includes at least one vacuum hole of the plurality of vacuum holes configured to facilitate application of the vacuum on the circular portion of the glass sheet.

9. The method of claim 5, wherein:
the first circular path and the second circular path are concentric, and
the glass substrate disk, the first circular protrusion, and the second circular protrusion are concentric.

10. The method of claim 1, wherein the applying the first laser comprises moving a position of the support plate with respect to a position of a first laser device applying the first laser, and
wherein the applying the second laser to cut the glass sheet along the first circular path comprises optically moving a focus of the second laser to cut the glass sheet along the first circular path while a position of a second laser device applying the second laser remains about stationary with respect to the glass sheet, and
wherein the applying the second laser to cut the glass sheet along the second circular path comprises optically moving the focus of the second laser to cut the glass sheet along the second circular path while the position of the second laser device remains about stationary with respect to the glass sheet.

11. The method of claim 1, wherein the first laser is a neodymium-doped yttrium aluminum garnet (Nd:YAG) laser and the second laser is a carbon dioxide laser.

12. A support plate for fabricating a glass substrate disk for a data storage device from a glass sheet, comprising:
a baseplate;
a first circular protrusion disposed on a top surface of the baseplate, wherein the first circular protrusion is configured to provide a support surface for an inner diameter edge of the glass substrate disk and to enclose a first recess configured to receive a circular portion of the glass sheet after separation of the circular portion;
a second circular protrusion disposed on the top surface of the baseplate, wherein the second circular protrusion is configured to provide a support surface for an outer diameter edge of the glass substrate disk; and
a plurality of vacuum holes configured to facilitate application of a vacuum on a portion of the glass sheet to affix the glass sheet to the support plate when the glass sheet is disposed on the first circular protrusion and the second circular protrusion.

13. The support plate of claim 12,
wherein the first circular protrusion comprises at least one vacuum hole of the plurality of vacuum holes configured to facilitate application of the vacuum on a first portion the glass sheet in contact with the first circular protrusion; and
wherein the second circular protrusion comprises at least one vacuum hole of the plurality of vacuum holes configured to facilitate application of the vacuum on a second portion of the glass sheet in contact with the second circular protrusion.

14. The support plate of claim 12, wherein the first recess includes at least one vacuum hole of the plurality of vacuum holes configured to facilitate application of the vacuum on the circular portion of the glass sheet.

15. The support plate of claim 12:
wherein a cross sectional shape of the first circular protrusion, taken across a plane extending in a radial direction of the first circular protrusion, comprises a first flat top mountain shape where the glass sheet is configured to rest on a first flat portion of the first flat top mountain shape, and
wherein a cross sectional shape of the second circular protrusion, taken across a plane extending in a radial direction of the second circular protrusion, comprises a second flat top mountain shape where the glass sheet is configured to rest on a second flat portion of the second flat top mountain shape.

16. The support plate of claim 12, wherein the second circular protrusion encloses a second recess disposed between the second circular protrusion and the first circular protrusion.

17. The support plate of claim 12, wherein the glass substrate disk, the first circular protrusion, and the second circular protrusion are concentric.

18. An apparatus for cutting the glass sheet to fabricate the glass substrate disk for data storage, the apparatus comprising:
the support plate of claim 12;
a first laser device configured to apply a first laser to form a plurality of first holes through the glass sheet along a first circular path to correspond to an inner diameter edge of the glass substrate disk and to form a plurality of second holes through the glass sheet along a second circular path to correspond to an outer diameter edge of the glass substrate disk;
a second laser device configured to apply a second laser to cut the glass sheet along the first circular path and along the second circular path, the second laser having a greater wavelength than that of the first laser;
a vacuum device configured to apply the vacuum to the glass sheet via the plurality of vacuum holes to affix the glass sheet on the support plate and to cause, in conjunction with gravity, a circular portion of the glass sheet with a perimeter corresponding to the first circular path to be separated from the glass sheet; and
a platform configured to move the support plate in at least one direction, relative to at least one of the first laser device or the second laser device.

19. The apparatus of claim 18, wherein the vacuum device is configured to apply the vacuum on the glass sheet to affix the glass sheet on the support plate, and wherein the first laser device is configured to apply the first laser to form the plurality of first holes and to form the plurality of second holes in conjunction with the vacuum.

20. The apparatus of claim 19, wherein the second laser is configured to cut the glass sheet along the first circular path without the vacuum.

21. The apparatus of claim 18:
wherein the platform is configured to move the support plate relative to the first laser device configured to apply the first laser,
wherein the second laser device is further configured to optically move a focus of the second laser to cut the glass sheet along the first circular path while the second laser device remains about stationary with respect to the glass sheet, and
wherein the second laser device is further configured to optically move the focus of the second laser to cut the glass sheet along the second circular path while the second laser device remains about stationary with respect to the glass sheet.

22. The support plate of claim 18, wherein the glass substrate disk, the first circular protrusion, and the second circular protrusion are concentric.

23. The support plate of claim 18, wherein the first laser is a neodymium-doped yttrium aluminum garnet (Nd:YAG) laser and the second laser is a carbon dioxide laser.
